(19) United States
(12) Patent Application Publication
(10) Pub. No.: US 2022/0148429 A1
(43) Pub. Date: May 12, 2022

(54) EDGE COMPUTING SERVER, CONTROL METHOD, AND NON-TRANSITORY COMPUTER-READABLE MEDIUM

(71) Applicant: NEC Corporation, Minato-ku, Tokyo (JP)

(72) Inventor: Shuhei IGUCHI, Tokyo (JP)

(73) Assignee: NEC Corporation, Minato-ku, Tokyo (JP)

(21) Appl. No.: 17/437,156

(22) PCT Filed: Nov. 27, 2019
(86) PCT No.: PCT/JP2019/046301

§ 371 Date: Sep. 8, 2021

(30) Foreign Application Priority Data
Mar. 18, 2019 (JP) 2019-049338

(51) Int. Cl. G08G 1/16; G08G 1/09; G08G 1/01

(52) U.S. Cl. CPC G08G 1/163; G08G 1/0112; G08G 1/0125; G08G 1/094

(57) ABSTRACT

An edge server (10) periodically acquires, by an acquisition unit (11), a location of each communication apparatus (30-1 to 30-N). A control unit (12) identifies an accident-occurrence predicted communication apparatus (30) disposed in an “accident-occurrence predicted vehicle” which is vehicle regarding which there is a high probability of it causing an accident among the communication apparatuses (30-1 to 30-N) based on the location of each communication apparatus (30) acquired by the acquisition unit (11). The transmission unit (13) transmits a “warning message” to the accident-occurrence predicted communication apparatus (30) identified by the control unit (12) via the base station (20).

### TECHNICAL FIELD

The present disclosure relates to an edge computing server, a control method, and a control program.

### BACKGROUND ART

An edge computing technology for performing data processing by installing a server at a location near a user is proposed (for instance, Patent Literature 1). An edge computing server of a communication system disclosed in Patent Literature 1 is installed while being connected with a radio access network, and the server is configured to transmit a message indicating control information derived from the characteristics of a radio terminal to a radio access network node (e.g., a base station).

### CITATION LIST

### Patent Literature

Patent Literature 1: Japanese Unexamined Patent Application Publication No. 2017-17655

### SUMMARY OF INVENTION

### Technical Problem

The inventors of the present disclosure have found an edge computing technology for improving the accuracy to prevent traffic accidents.

An object of the present disclosure is to provide an edge computing server, a control method, and a control program capable of improving the accuracy to prevent traffic accidents.

### Solution to Problem

An edge computing server according to a first aspect is an edge computing server installed while being connected with a radio access network including a base station, the edge computing server including:

an acquisition unit configured to periodically acquire a location of each communication apparatus from a plurality of communication apparatuses including a plurality of on-board communication apparatuses disposed in a plurality of vehicles and present within a target area;

a control unit configured to identify an accident-occurrence predicted communication apparatus disposed in an accident-occurrence predicted vehicle regarding which a high probability of occurrence of an accident is predicted among the plurality of vehicles based on the acquired location of each communication apparatus; and

a transmission unit configured to transmit a warning message to the identified accident-occurrence predicted communication apparatus via the base station.

A control method according to a second aspect is a control method performed by an edge computing server installed while being connected with a radio access network including a base station, the method including:

periodically acquiring a location of each communication apparatus from a plurality of communication apparatuses including a plurality of on-board communication apparatuses disposed in a plurality of vehicles and present within a target area;

identifying an accident-occurrence predicted communication apparatus disposed in an accident-occurrence predicted vehicle regarding which a high probability of occurrence of an accident is predicted among the plurality of vehicles based on the acquired location of each communication apparatus; and

transmitting a warning message to the identified accident-occurrence predicted communication apparatus via the base station.

A control program according to a third aspect causes an edge computing server installed while being connected with a radio access network including a base station to perform the processes of:

periodically acquiring a location of each communication apparatus from a plurality of communication apparatuses including a plurality of on-board communication apparatuses disposed in a plurality of vehicles and present within a target area;

identifying an accident-occurrence predicted communication apparatus disposed in an accident-occurrence predicted vehicle regarding which a high probability of occurrence of an accident is predicted among the plurality of vehicles based on the acquired location of each communication apparatus; and

transmitting a warning message to the identified accident-occurrence predicted communication apparatus via the base station.

### Advantageous Effects of Invention

According to the present disclosure, an edge computing server, a control method, and a control program capable of improving the accuracy to prevent traffic accidents.

### BRIEF DESCRIPTION OF DRAWINGS

FIG. 1 is a diagram showing an example of a communication system according to a first example embodiment;

FIG. 2 is a block diagram showing an example of an edge computing server according to the first example embodiment;

FIG. 3 is a block diagram showing an example of an edge computing server according to a second example embodiment;

FIG. 4 is a diagram showing an example of a communication system according to a third example embodiment;

FIG. 5 is a block diagram showing an example of an edge computing server according to the third example embodiment;

FIG. 6 is a diagram for explaining a specific example of the third example embodiment;

FIG. 7 is a diagram for explaining a specific example of the third example embodiment;

FIG. 8 is a diagram showing an example of a communication system according to a fourth example embodiment;

FIG. 9 is a block diagram showing an example of an edge computing server according to the fourth example embodiment; and

FIG. 10 is a diagram showing an example of a hardware configuration of an edge computing server.

### DESCRIPTION OF EMBODIMENTS

Hereinbelow, example embodiments will be described with reference to the drawings. Note that identical reference symbols denote identical or equivalent structural elements and the redundant explanations thereof are omitted.

### First Example Embodiment

<Outline of Communication System>

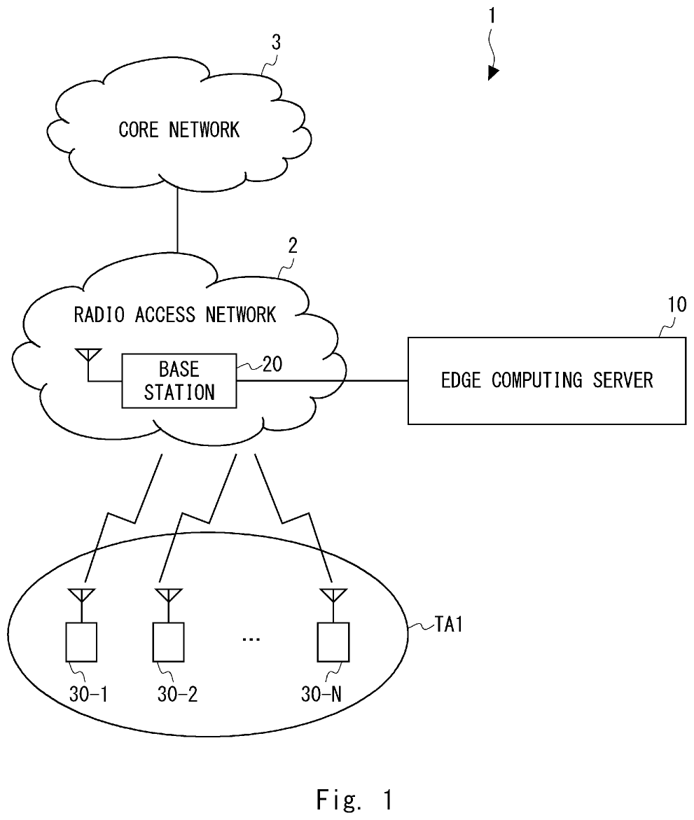

FIG. 1 is a diagram showing an example of a communication system according to a first example embodiment. In FIG. 1, a communication system 1 includes a radio access network 2 and a core network 3. A base station 20 is installed in the radio access network 2. An edge computing server 10 is connected to the base station 20. The edge computing server 10 may be installed within the radio access network 2 or may be installed outside the radio access network 2. In brief, the edge computing server 10 may be installed while being connected with the radio access network 2. The edge computing server 10 may be further connected to the core network 3. Hereinbelow, the edge computing server 10 may also be referred to as an “edge server 10”.

Further, the communication system 1 includes communication apparatuses 30-1 to 30-N (N is a natural number equal to or greater than 2) within a “target area TA1”. The “target area TA1” is a prescribed area within the cell of the base station 20, for instance, an intersection area and its surrounding area. Hereinbelow, when the communication apparatuses 30-1 to 30-N are not distinguished from one another, they are simply referred to as the communication apparatus 30.

The communication apparatus 30 performs radio communication with the base station 20. Further, the communication apparatus 30 is an “on-board communication apparatus” disposed in a vehicle, and may be a communication apparatus mounted on a vehicle or a communication apparatus such as a mobile terminal present within the vehicle. For instance, the communication apparatus 30 periodically transmits identification information of the communication apparatus 30 and location information of the communication apparatus 30 to the base station 20.

<Example of Configuration of Edge Server>

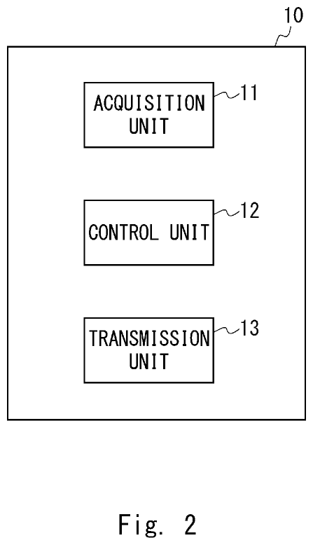

FIG. 2 is a block diagram showing an example of the edge computing server according to the first example embodiment. In FIG. 2, the edge server 10 includes an acquisition unit 11, a control unit 12, and a transmission unit 13.

The acquisition unit 11 periodically acquires respective locations of the communication apparatuses 30-1 to 30-N. The acquisition unit 11 may acquire the respective locations of the communication apparatuses 30-1 to 30-N via the base station 20 or via the core network 3. That is, the acquisition unit 11 may include a communication interface (not shown) with the base station 20 or may include a communication interface with the core network 3.

The control unit 12 identifies the communication apparatus 30 disposed in an “accident-occurrence predicted vehicle” (hereinbelow, also referred to as an “accident-occurrence predicted communication apparatus 30”), which is a vehicle regarding which there is a high probability of it causing an accident, from among the communication apparatuses 30-1 to 30-N based on the respective locations of the communication apparatuses 30-1 to 30-N acquired by the acquisition unit 11.

The transmission unit 13 transmits a “warning message” to the accident-occurrence predicted communication apparatus 30 identified by the control unit 12 via the base station 20.

As described above, according to the first example embodiment, in the edge server 10, the acquisition unit 11 periodically acquires the respective locations of the communication apparatuses 30-1 to 30-N. The control unit 12 identifies the accident-occurrence predicted communication apparatus 30 disposed in an “accident-occurrence predicted vehicle”, which is a vehicle regarding which there is a high probability of it causing an accident, from among the communication apparatuses 30-1 to 30-N based on the location of each communication apparatus 30 acquired by the acquisition unit 11. The transmission unit 13 transmits a “warning message” to the accident-occurrence predicted communication apparatus 30 identified by the control unit 12 via the base station 20.

Such configuration of the edge server 10 makes it possible to realize an edge server that can improving the accuracy to prevent traffic accidents.

### Second Example Embodiment

A second example embodiment relates to a more specific example embodiment.

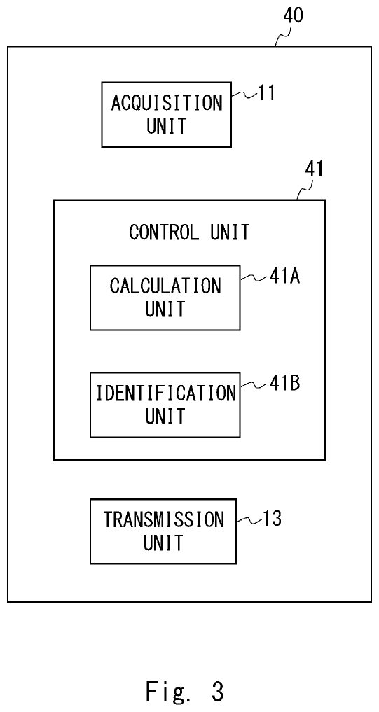

FIG. 3 is a block diagram showing an example of an edge computing server according to the second example embodiment. Note that since the basic configuration of the communication system according to the second example embodiment is the same as that of the communication system 1 according to the first example embodiment, it will be explained with reference to FIG. 1. That is, the communication system according to the second example embodiment is configured by replacing the edge server 10 shown in FIG. 1 by an edge server 40.

In FIG. 3, the edge server 40 includes the acquisition unit 11, a control unit 41, and the transmission unit 13.

The control unit 41 includes a calculation unit 41A and an identification unit 41B.

The calculation unit 41A calculates the current location and the moving characteristics of each communication apparatus 30 based on the respective locations of the communication apparatuses 30-1 to 30-N. For instance, the calculation unit 41A calculates that a communication apparatus 30 is in a lane for right-turn traffic at an intersection that is within the target area as the “current location” of the instant communication apparatus 30 from the map information and the location of the instant communication apparatus 30, and that the instant communication apparatus 30 has entered and stopped at the intersection as the “moving characteristics” of the instant communication apparatus 30 from the location history of the instant communication apparatus 30. Further, for instance, the calculation unit 41A calculates that a communication apparatus 30 is in a lane for straight-through traffic at an intersection and has not yet entered the intersection as the “current location” of the instant communication apparatus 30 from the map information and the location of the instant communication apparatus 30, and that the instant communication apparatus 30 is about to enter the intersection without slowing down as the “moving characteristics” of the instant communication apparatus 30 from the location history of the instant communication apparatus 30.

The identification unit 41B identifies the accident-occurrence predicted communication apparatus 30 from among the communication apparatuses 30-1 to 30-N based on the current location and the moving characteristics of each communication apparatus 30 calculated by the calculation unit 41A. For instance, the identification unit 41B holds information related to an “accident occurrence pattern”. Then, the identification unit 41B determines whether or not the current location and the moving characteristics of each of the first communication apparatus and the second communication apparatus that make up a “communication apparatus pair” among the communication apparatuses 30-1 to 30-N match the “accident occurrence pattern”. Then, the identification unit 41B identifies the first communication apparatus and the second communication apparatus that make up a communication apparatus pair determined to match the accident occurrence pattern as the accident-occurrence predicted communication apparatuses. For instance, the accident occurrence pattern includes a pattern in which a communication apparatus 30 is in each of the two oncoming lanes for right-turn traffic and a communication apparatus 30 about to enter an intersection without slowing down is in a lane for straight-through traffic.

As described above, according to the second example embodiment, the calculation unit 41A of the control unit 41 of the edge server 40 calculates the current location and the moving characteristics of each communication apparatus 30 based on the respective locations of the communication apparatuses 30-1 to 30-N. The identification unit 41B identifies the accident-occurrence predicted communication apparatus 30 from among the communication apparatuses 30-1 to 30-N based on the current location and the moving characteristics of each communication apparatus 30 calculated by the calculation unit 41A.

Such configuration of the edge server 40 makes it possible to identify the accident-occurrence predicted apparatus 30 with precision.

### Third Example Embodiment

A third example embodiment relates to an example embodiment in which “an accident-impact area” is taken into consideration.

<Outline of Communication System>

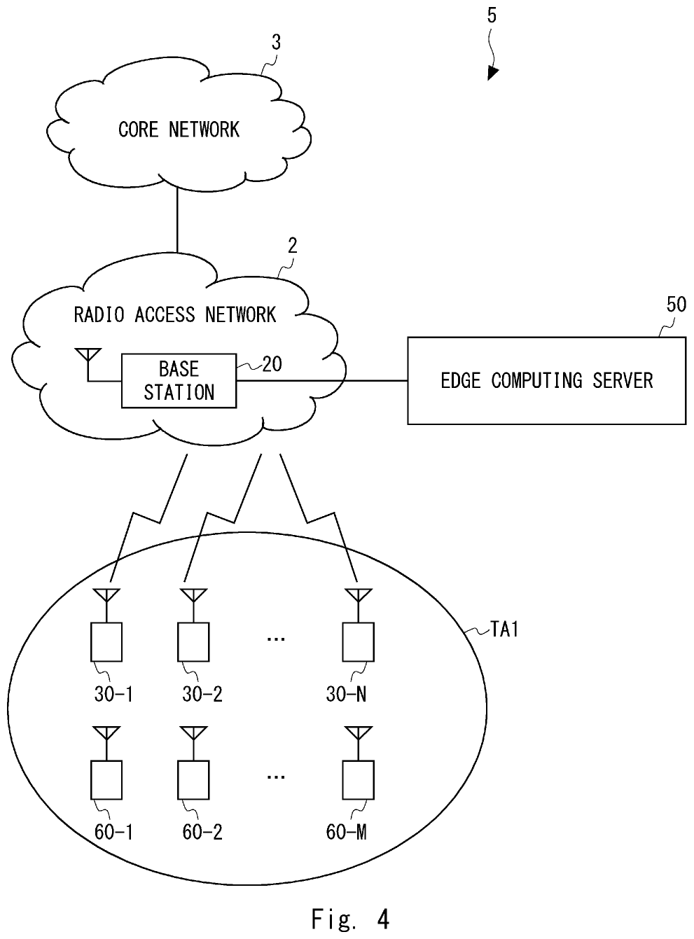

FIG. 4 is a diagram showing an example of a communication system according to a third example embodiment. A communication system 5 shown in FIG. 4 differs from the communication system 1 shown in FIG. 1 in that it includes an edge server 50 in place of the edge server 10 and that there are communication apparatuses 60-1 to 60-M (M is a natural number equal to greater than 2) within the target area TA1. Hereinbelow, when the communication apparatuses 60-1 to 60-M are not distinguished from one another, they are simply referred to as the communication apparatus 60.

The communication apparatus 60 performs radio communication with the base station 20. Further, the communication apparatus 60 is, for instance, a communication apparatus carried by a pedestrian (i.e. “a non-on-board communication apparatus”). For instance, the communication apparatus 60 periodically transmits the identification information of the communication apparatus 60 and the location information of the communication apparatus 60 to the base station 20. Further, for instance, the communication apparatus 30 and the communication apparatus 60 may transmit the respective identification information and location information as well as the “terminal type information” indicating whether the apparatus is an on-board communication apparatus or a non-on-board communication apparatus. With such configuration, the edge server 50 can identify the terminal type of each of the communication apparatus 30 and the communication apparatus 60.

<Example of Configuration of Edge Server>

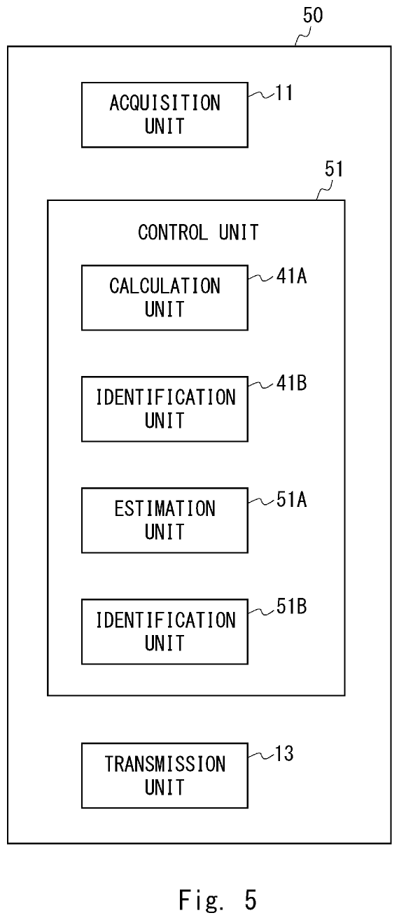

FIG. 5 is a block diagram showing an example of an edge computing server according to the third example embodiment. In FIG. 5, the edge server 50 includes the acquisition unit 11, a control unit 51, and the transmission unit 13. The control unit 51 includes the calculation unit 41A, the identification unit (a first identification unit) 41B, an estimation unit 51A, and an identification unit (a second identification unit) 51B.

The acquisition unit 11 periodically acquires the respective locations of the communication apparatuses 30-1 to 30-N. Further, the acquisition unit 11 periodically acquires the respective locations of the communication apparatuses 60-1 to 60-M. The acquisition unit 11 may acquire the respective locations of the communication apparatuses 30-1 to 30-N and the communication apparatuses 60-1 to 60-M via the base station 20 or via the core network 3.

The estimation unit 51A estimates the “accident-impact area” based on the current location and the moving characteristics of the accident-occurrence predicted communication apparatus 30 identified by the identification unit 41B. For instance, the estimation unit 51A may estimate the accident-impact area so that the faster the speed of the accident-occurrence predicted communication apparatus 30 is, the larger the radius of the accident impact area centered on the current location of the accident-occurrence predicted communication apparatus 30 becomes. Note that here, it is assumed that the accident-impact area is an area included in the aforementioned target area and smaller than the aforementioned target area.

The identification unit 51B identifies the accident-affected communication apparatuses 30 and 60 present within the estimated accident-impact area from among the communication apparatuses 30-1 to 30-N and the communication apparatuses 30-1 to 60-M. Note that when the communication apparatus 60 present inside a building can be identified, the identification unit 51B may exclude the communication apparatus 60 from the accident-affected communication apparatus.

The transmission unit 13 transmits a “warning message” to the accident-occurrence predicted communication apparatus 30 identified by the identification unit 41B and the accident-affected communication apparatuses 30 and 60 identified by the identification unit 51B via the base station 20.

### Specific Examples

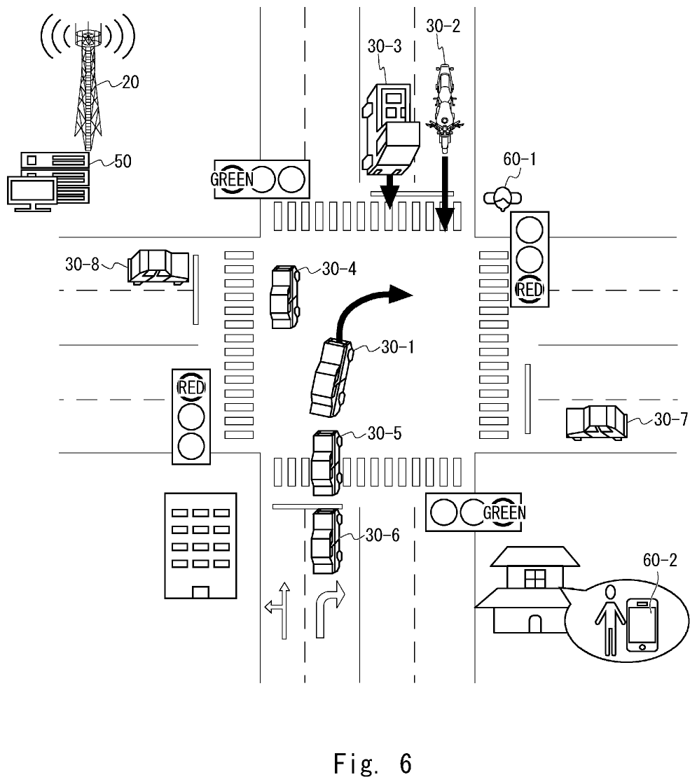

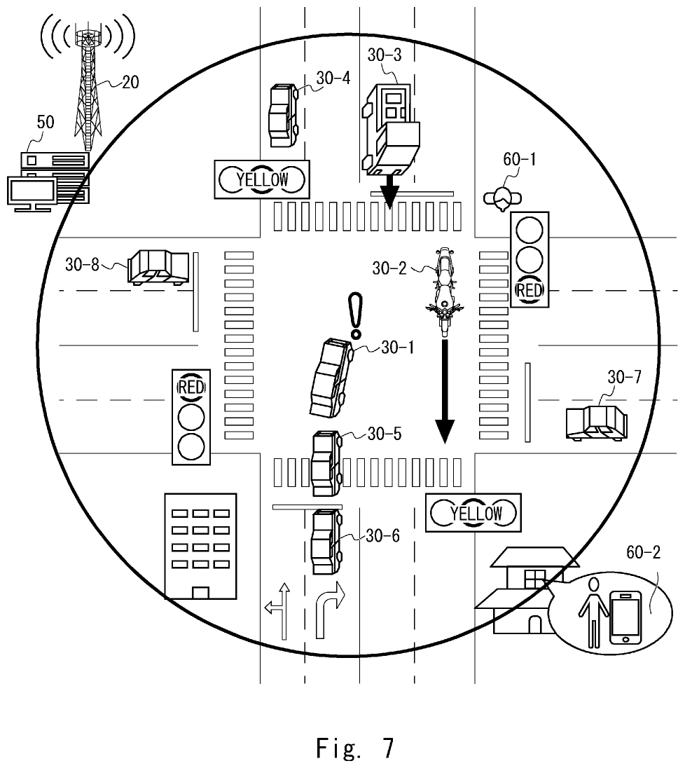

FIGS. 6 and 7 are diagrams for explaining a specific example of the third example embodiment. In FIGS. 6 and 7, an intersection area and a part of its surrounding area are shown as the target area. In the target area, there are communication apparatuses 30-1 to 30-8 which are on-board communication apparatuses and communication apparatuses 30-1 and 60-2 which are non-on-board communication apparatuses.

In the situation of the target area shown in FIG. 6, the vehicle in which the communication apparatus 30-1 is disposed has entered the intersection from the lane for right-turn traffic and advanced to the vicinity of center of the intersection to be on standby thereat. Just now, the traffic light is about change from green to yellow as seen from the vehicle in which the communication apparatus 30-1 is disposed. Then, a vehicle (a truck) in which the communication apparatus 30-3 is disposed, which is an oncoming vehicle as seen from vehicle on which the communication apparatus 30-1 is disposed, slows down to stop while a vehicle (a motorcycle) in which the communication apparats 30-2 is disposed is about to enter the intersection without slowing down.

In the situation shown in FIG. 6, the identification unit 41B of the edge server 50 identifies the communication apparatuses 30-1 and 30-2 as the accident-occurrence predicted communication apparatus 30. Then, the estimation unit 51A estimates the accident-impact area. Here, it is assumed to be the area inside the circle shown in FIG. 7 is the accident-impact area. The, the identification unit 51B identifies the accident-affected communication apparatuses 30 and 60 present within the accident-occurrence estimated area.

Here, as shown in FIG. 7, the communication apparatuses 30-3 to 30-8 and the communication apparatuses 60-1 and 60-2 are identified as the accident-affected communication apparatuses. Note that the communication apparatus 60-2 present inside a building may be excluded from the aforementioned accident-affected communication apparatus.

Then, the transmission unit 13 transmits a “warning message” to the communication apparatuses 30-1 and 60-2 which are accident-occurrence predicted communication apparatuses identified by the identification unit 41B and the communication apparatuses 30-3 to 30-8 and the communication apparatuses 60-1 and 60-2 which are accident-affected communication apparatuses identified by the identification unit 51B. By this configuration, the communication apparatus 30-1 receives the warning message whereby the driver of the vehicle in which the communication apparatus 30-1 is disposed can refrain from starting the vehicle and as a result, the collision can be avoided. Further, the communication apparatuses 30-3 to 30-8 and the communication apparatuses 60-1 and 60-2, which are accident-affected communication apparatuses, can also receive the warning message whereby the users of the communication apparatuses 30-3 to 30-8 and the communication apparatuses 60-1 and 60-2 can also prepare for the accident.

### Modified Example

Note that in the description given above, it is assumed that the estimation unit 51A estimates the accident-impact area, however it is not limited thereto and the “accident-impact area” may be a fixed area. In this case, for instance, the aforementioned target area may be used as the accident-impact area.

### Fourth Example Embodiment

A fourth example embodiment relates to an example embodiment in which an edge server controls allocation of a radio resource by a base station.

<Outline of Communication System>

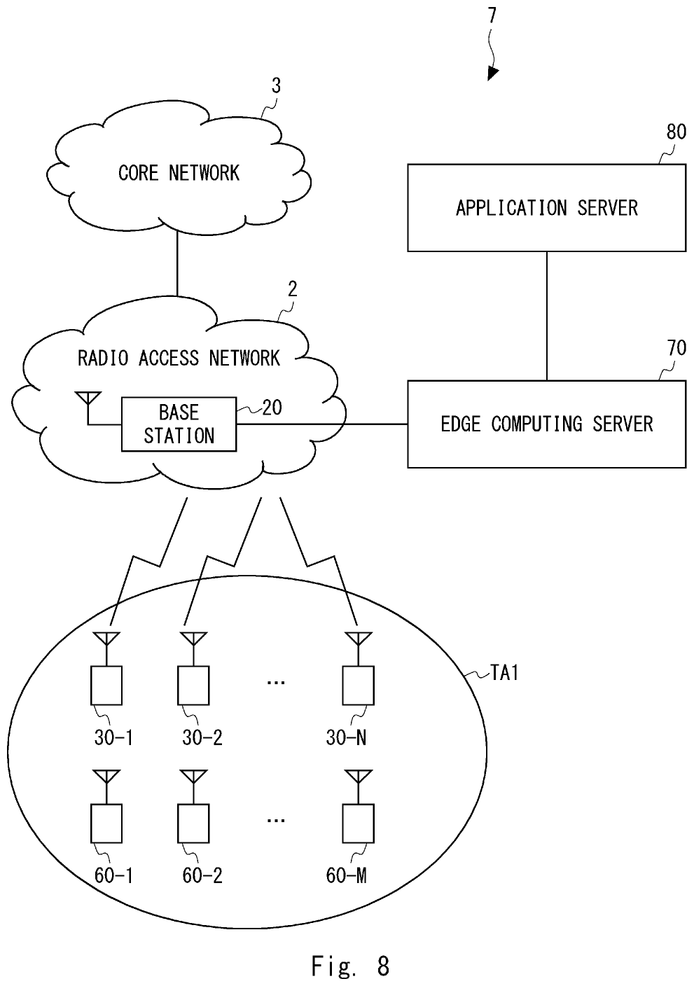

FIG. 8 is a diagram showing an example of a communication system according to the fourth example embodiment. A communication system 7 shown in FIG. 8 differs from the communication system 5 shown in FIG. 4 in that it includes an edge server 70 in place of the edge server 50 and that an application server (APL server) 80 is further included. The edge server 70 and the application server 80 are connected with each other.

<Example of Configuration of Edge Server>

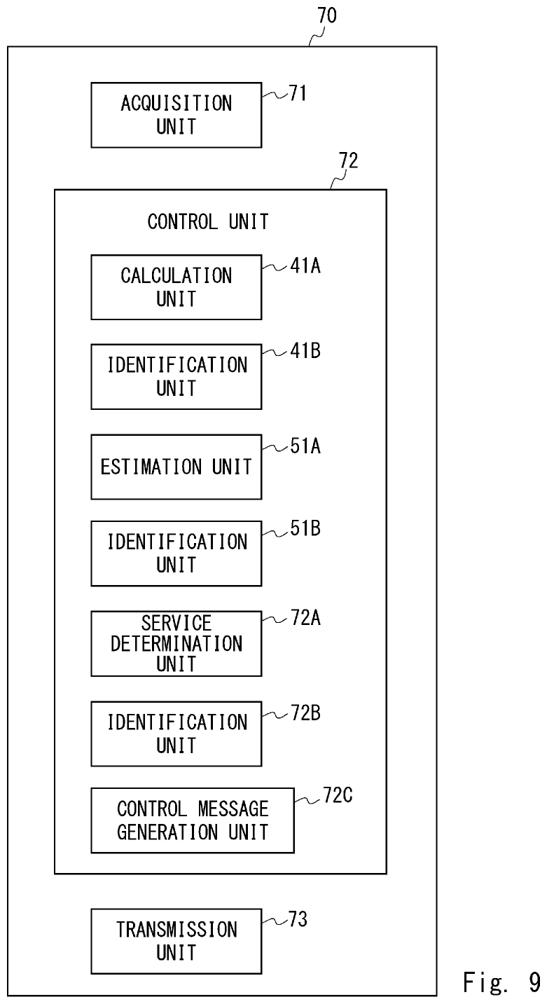

FIG. 9 is a block diagram showing an example of an edge computing server according to the fourth example embodiment. In FIG. 9, the edge server 70 includes an acquisition unit 71, a control unit 72, and a transmission unit 73.

The acquisition unit 71 periodically acquires the respective locations of the communication apparatuses 30-1 to 30-N and the communication apparatuses 60-1 to 60-M like the acquisition unit 11 according to the third example embodiment. Further, the acquisition unit 71 acquires the respective “communication characteristics” of the communication apparatuses 30-1 to 30-N and the communication apparatuses 60-1 to 60-M from the base station 20. Here, the “communication characteristics” include, for instance, data size and throughput. Further, the acquisition unit 71 acquires the “correspondence relationship” among the plurality of services and the QoS (Quality of Service) for each service from the application server 80. That is, the acquisition unit 71 includes a communication interface (not shown) with the application server 80.

The control unit 72 includes the calculation unit 41A, the identification unit (the first identification unit) 41B, the estimation unit 51A, the identification unit (the second identification unit) 51B, a service decision unit 72A, an identification unit (a third identification unit) 72B, and a control message generation unit 72C.

The service decision unit 72a decides the “service” for each of the accident-occurrence predicted communication apparatus 30 identified by the identification unit 41B and the accident-affected communication apparatuses 30 and 60 identified by the identification unit 51B. The decided service includes, for instance, “low delay service”.

The identification unit 72B identifies the QoS corresponding to the service decided by the service decision unit 72A in the aforementioned correspondence relationship. Then, the identification unit 72B identifies a “communication apparatus group” consisting of the communication apparatuses having corresponding communication characteristics that do not satisfy the identified QoS from among the accident-occurrence predicted communication apparatus 30 and the accident-affected communication apparatuses 30 and 60. More specifically, the identification unit 72B calculates the data size/throughput (=communication time) and compares the calculated communication time with the identified QoS, whereby the “communication apparatus group” consisting of the communication apparatuses having corresponding communication characteristics that do not satisfy the identified QoS is identified.

The control message generation unit 72C generates the “control message” for controlling allocation of the radio resource by the base station 20 to the communication apparatus included in the “communication apparatus group” identified by the identification unit 72B, and transmits the message to the base station 20 via the transmission unit 73.

For instance, the control message generation unit 72C may generate a “control message” for increasing the radio resource allocated to the communication apparatus included in the “communication apparatus group” identified by the identification unit 72B. Further, for instance, the control message generation unit 72C may generate a “control message” for preferentially allocating a radio resource to a communication apparatus in an ascending order of the difference between the QoS and the corresponding communication characteristics, the QoS corresponding to the decided service in the aforementioned correspondence relationship. By this configuration, it is possible to secure the QoS for a large number of communication apparatuses that constitute the aforementioned “communication apparatus group”. Note that the control message generation unit 72C may list the communication apparatuses in the ascending order of the difference between the QoS and the corresponding communication characteristics, the QoS corresponding to the decided service in the aforementioned correspondence relationship, among the plurality of communication apparatuses included in the “communication apparatus group” and transmit a control message including the listed information (QoS requirements) to the base station 20.

The transmission unit 73 transmits the control message generated by the control message generation unit 72C and the warning message to the base station 20. By this configuration, the base station 20 allocates the radio resource to the accident-occurrence predicted communication apparatus 30 and the accident-affected communication apparatuses 30 and 60, and transmits a warning message wirelessly using the allocated radio resource to the accident-occurrence predicted communication apparatus 30 and the accident-affected communication apparatuses 30 and 60.

### Other Example Embodiments

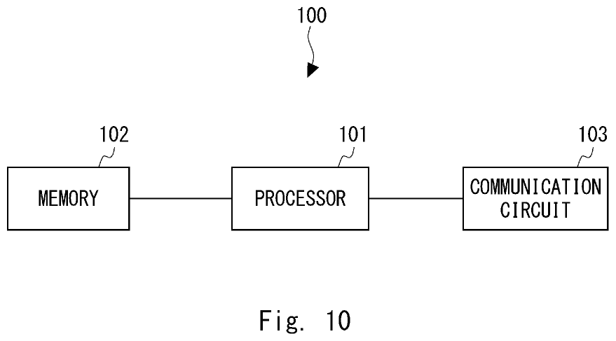

FIG. 10 is a diagram showing an example of a hardware configuration of an edge computing server. In FIG. 10, the edge server 100 includes a processor 101, a memory 102, and a communication circuit 103. The processor 101 may be, for instance, a microprocessor, MPU (Micro Processing Unit), or a CPU (Central Processing Unit). The processor 101 may include a plurality of processors. The memory 102 may be configured by combining a volatile memory and a non-volatile memory. The memory 102 may include a storage disposed separately from the processor 101. In this case, the processor 101 may access the memory 102 via an unillustrated I/O interface.

The edge servers 10, 40, 50, and 70 according to the first to the fourth example embodiments may each include the hardware configuration shown in FIG. 10. The control units 12, 41, 51, and 72 of the edge servers 10, 40, 50, and 70 according to the first to the fourth example embodiments may be realized by causing the processor 101 read and execute the program stored in the memory 102. Further, acquisition units 11 and 71 and the transmission units 13 and 73 of the edge servers 10, 40, 50, and 70 according to the first to the fourth example embodiments may be realized by the transmission circuit 103. The program can be stored and provided to the edge servers 10, 40, 50, and 70 using any type of non-transitory computer readable media. Examples of non-transitory computer readable media include magnetic storage media (such as floppy disks, magnetic tapes, hard disk drives, etc.) and optical magnetic storage media (e.g. magneto-optical disks). Further, examples of non-transitory computer readable media include CD-ROM (compact disc read only memory), CD-R, and CD-R/W. Further, examples of non-transitory computer readable media include semiconductor memories. Examples of semiconductor memories include mask ROM, PROM (programmable ROM), EPROM (Erasable PROM), flash ROM, RAM (random access memory), etc. The program may be provided to the edge servers 10, 40, 50, and 70 using any type of transitory computer readable media. Examples of transitory computer readable media include electric signals, optical signals, and electromagnetic waves. Transitory computer readable media can provide the program to the edge servers 10, 40, 50, and 70 via a wired communication line (e.g. electric wires, and optical fibers) or a wireless communication line.

The present invention has been explained above with reference to the example embodiments. However, the present invention is not limited to the above-described embodiments. The configuration and the details of the present disclosure may be varied in many ways without departing from the scope of the present disclosure.

This application is based upon and claims the benefit of priority from Japanese patent application No. 2019-049338, filed on Mar. 18, 2019, the disclosure of which is incorporated herein in its entirety by reference.

### REFERENCE SIGNS LIST

1 COMMUNICATION SYSTEM
2 RADIO ACCESS NETWORK
3 CORE NETWORK
5 COMMUNICATION SYSTEM
7 COMMUNICATION SYSTEM
10 EDGE COMPUTING SERVER
11 ACQUISITION UNIT
12 CONTROL UNIT
13 TRANSMISSION UNIT
20 BASE STATION
30 COMMUNICATION APPARATUS
40 EDGE COMPUTING SERVER
41 CONTROL UNIT
41A CALCULATION UNIT
41B IDENTIFICATION UNIT (FIRST IDENTIFICATION UNIT)
50 EDGE COMPUTING SERVER
51 CONTROL UNIT
51A ESTIMATION UNIT
51B IDENTIFICATION UNIT (SECOND IDENTIFICATION UNIT)
60 COMMUNICATION APPARATUS
70 EDGE COMPUTING SERVER
71 ACQUISITION UNIT
72 CONTROL UNIT
72A SERVICE DECISION UNIT
72B IDENTIFICATION UNIT (THIRD IDENTIFICATION UNIT)
72C CONTROL MESSAGE GENERATION UNIT
73 TRANSMISSION UNIT
80 APPLICATION SERVER (APL SERVER)

What is claimed is:

1. An edge computing server installed while being connected with a radio access network including a base station, the edge computing server comprising:
a communication circuit;
hardware including at least one processor and at least one memory;
acquisition unit implemented at least by the communication circuit and that periodically acquires a location of each communication apparatus from a plurality of communication apparatuses including a plurality of on-board communication apparatuses disposed in a plurality of vehicles and present within a target area;
control unit implemented at least by the hardware and that identifies an accident-occurrence predicted communication apparatus disposed in an accident-occurrence predicted vehicle regarding which a high probability of occurrence of an accident is predicted among the plurality of vehicles based on the acquired location of each communication apparatus; and
transmission unit implemented at least by the communication circuit and that transmits a warning message to the identified accident-occurrence predicted communication apparatus via the base station.

2. The edge computing server according to claim 1, wherein the control unit comprises:
calculation unit configured to calculates a current location and moving characteristics of each communication apparatus based on respective locations of the plurality of communication apparatuses; and
first identification unit configured to identify the accident-occurrence predicted communication apparatus among the plurality of communication apparatuses based on the calculated current location and moving characteristics of each communication apparatus.

3. The edge computing server according to claim 2, wherein the first identification unit determines whether or not the current locations and the moving characteristics of a first communication apparatus and a second communication apparatus that make up a communication apparatus pair among the plurality of communication apparatuses match an accident occurrence pattern, and identifies the first communication apparatus and the second communication apparatus that make up a communication apparatus pair determined to match the accident occurrence pattern as the accident-occurrence predicted communication apparatuses.

4. The edge computing server according to claim 2, wherein
the control unit comprises:
estimation unit configured to estimates an accident impact area based on the current location and the moving characteristics of the identified accident-occurrence predicted communication apparatuses; and
second identification unit configured to identify a plurality of accident-affected communication apparatuses present within the accident impact area among the plurality of communication apparatuses, and
the transmission unit transmits the warning message to the plurality of identified accident-affected communication apparatuses via the base station.

5. The edge computing server according to claim 4, wherein
the acquisition unit acquires a correspondence relationship between a plurality of services and QoS for each service and communication characteristics of each communication apparatus, and
the control unit comprises:
service determination unit configured to determine services for the accident-occurrence predicted communication apparatus and the plurality of accident-affected communication apparatuses,
third identification unit configured to identify a group of communication apparatuses consisting of communication apparatuses having communication characteristics that do not satisfy the QoS corresponding to the determined service in the correspondence relationship among the accident-occurrence predicted communication apparatus and the plurality of accident-affected communication apparatuses, and
control message generation unit configured to generate a control message for controlling allocation of a radio resource by the base station to the communication apparatuses included in the identified group of communication apparatuses and transmit the control message via the transmission means.

6. The edge computing server according to claim 5, wherein the control message generation unit generates the control message for increasing a radio resource allocated to the communication apparatuses included in the identified group.

7. The edge computing server according to claim 5, wherein the control message generation unit generates the control message for preferentially allocating the radio resource to a communication apparatus in an ascending order of the difference between the corresponding communication characteristics and the QoS corresponding to the decided service in the correspondence relationship among the plurality of communication apparatuses included in the communication apparatus group.

8. A control method performed by an edge computing server installed while being connected with a radio access network including a base station, the method comprising:
periodically acquiring a location of each communication apparatus from a plurality of communication apparatuses including a plurality of on-board communication apparatuses disposed in a plurality of vehicles and present within a target area;
identifying an accident-occurrence predicted communication apparatus disposed in an accident-occurrence predicted vehicle regarding which a high probability of occurrence of an accident is predicted among the plurality of vehicles based on the acquired location of each communication apparatus; and
transmitting a warning message to the identified accident-occurrence predicted communication apparatus via the base station.

9. A non-transitory computer-readable medium storing a control program for causing an edge computing server installed while being connected with a radio access network including a base station to perform the processes of:
periodically acquiring a location of each communication apparatus from a plurality of communication apparatuses including a plurality of on-board communication apparatuses disposed in a plurality of vehicles and present within a target area;
identifying an accident-occurrence predicted communication apparatus disposed in an accident-occurrence predicted vehicle regarding which a high probability of occurrence of an accident is predicted among the plurality of vehicles based on the acquired location of each communication apparatus; and
transmitting a warning message to the identified accident-occurrence predicted communication apparatus via the base station.
